(19) United States
(12) Patent Application Publication
(10) Pub. No.: US 2002/0048016 A1
(43) Pub. Date: Apr. 25, 2002

(54) Apparatus and method for measuring refractive index profile of optical fiber or waveguide surface

(76) Inventors: Duck Young Kim, Kwangsan-ku (KR); Nak Hyoun Sung, Kongju (KR); Yong Woo Park, Seoul (KR); Young Choon Yook, Chunju (KR)

Correspondence Address: BACON & THOMAS, PLLC, 625 Slaters Lane, 4th Floor, Alexandria, VA, 22314-1176, US

(21) Appl. No.: 09/779,590

(22) Filed: Feb. 9, 2001

(30) Foreign Application Priority Data
Sep. 21, 2000 (KR) 10-200-55421

(51) Int. Cl. G01N 21/00

(52) U.S. Cl. 356/73.1

(57) ABSTRACT

Disclosed are an apparatus and method for measuring the refractive index distribution of an optical fiber or waveguide by measuring a variation in reflectivity on the surface of the optical fiber or waveguide depending upon the position on the surface of the optical fiber or waveguide while scanning the optical fiber or waveguide surface at a fixed scanning height using three laser beams of different wavelengths projected onto the optical fiber or waveguide surface. In accordance with the present invention, a high spatial resolution is obtained, as compared to conventional measuring devices using a refraction phenomenon. It is also possible to remarkably reduce measuring errors because a high signal-to-noise ratio is provided, as compared to conventional measuring devices using a scanning near field optical microscope. Also, there is an effect capable of achieving a precise measurement for the reflective index distribution essentially required in the design and manufacture of optical fibers or waveguides with a micro structure.

### BACKGROUND OF THE INVENTION

1. Field of the Invention

The present invention relates to an apparatus and method for measuring the refractive index profile of the surface of an optical fiber or waveguide, and more particularly to an apparatus and method for measuring the refractive index distribution of an optical fiber or waveguide by measuring a variation in reflectivity on the surface of the optical fiber or waveguide depending upon the position on the surface of the optical fiber or waveguide while scanning the optical fiber or waveguide surface at a fixed scanning height using three laser beams of different wavelengths projected onto the optical fiber or waveguide surface.

2. Description of the Related Art

Conventionally, measurement for the refractive index profile of the surface of an optical fiber or waveguide is carried out using a method, in which light is incident onto a side surface of the optical fiber or waveguide to measure the refraction of the light resulting from the refractive index profile of the optical fiber or waveguide surface, or a method in which light is projected onto the surface of the optical fiber or waveguide using a scanning near field optical microscope to measure a refractive index difference depending on the refractive index distribution in the optical fiber or waveguide.

The method for measuring the refraction of the incident laser beam based on a refraction phenomenon occurring in the optical fiber or waveguide has a drawback in that it is difficult to measure the refractive index distribution based on the optical fiber or waveguide profile in the case of a micro optical fiber or waveguide, due to a diffraction phenomenon of light occurring in the optical fiber or waveguide.

The measuring method using the scanning near field optical microscope has a drawback in that it is difficult to measure a micro variation in refractive index, to be measured, due to a low signal-to-noise ratio. Furthermore, this method has a problem in that considerable measurement errors may be generated even for a slight variation in the distance between the portion of the optical fiber or waveguide and a probe.

### SUMMARY OF THE INVENTION

Therefore, the present invention has been made in view of the above mentioned problems, and an object of the invention is to provide an apparatus and method for measuring the refractive index profile of an optical fiber or waveguide surface, which are capable of obtaining a high spatial resolution and a stability, as compared to the conventional measuring apparatus using a refraction phenomenon, and obtaining a high signal-to-noise ratio, as compared to the conventional measuring apparatus using a scanning near field optical microscope, thereby achieving a precise measurement for reflective index distribution.

In order to accomplish this object, the present invention provides an apparatus and method for measuring the refractive index distribution of an optical fiber or waveguide by measuring a variation in reflectivity on the surface of the optical fiber or waveguide depending upon the position on the surface of the optical fiber or waveguide while scanning the optical fiber or waveguide surface at a fixed scanning height using three laser beams of different wavelengths projected onto the optical fiber or waveguide surface.

Laser beams respectively emitted from three lasers having different wavelengths are guided along a single input optical fiber using wavelength division multiplexing couplers. The laser beams are incident onto a reflection surface after focusing by a lens or lensed fiber, and then partially reflected by the reflection surface and guided again to the output optical fiber.

When the reflection surface is arranged at the focus or beam waist of an incident laser beam emerging from the lense, the laser beam coupled output optical fiber and propagating in backward direction after being reflected by the reflection surface is maximized. The beam waist of the reflected laser beam varies depending on the wavelength of the laser beam. Based on this principle, the intensities of shortest and longest-wavelength laser beams fed back after being reflected by the reflection surface are detected, and fed back via a feedback loop. Based on the result of the detection, it is possible to allow the reflection surface to be always arranged at the focus of the intermediate-wavelength laser beam. Under the condition in which the reflection surface is maintained at the focus of the intermediate-wavelength laser beam, the power of the intermediate-wavelength laser beam fed back after being reflected by the reflection surface is detected as the reflection surface is scanned. Based on the result of the detection, accordingly, the reflective index of the reflection surface can be derived.

### BRIEF DESCRIPTION OF THE DRAWINGS

The above objects, and other features and advantages of the present invention will become more apparent after a reading of the following detailed description when taken in conjunction with the drawings, in which:

FIG. 1 is a view illustrating the principle of a measuring method using an optical fiber and a lens in accordance with the present invention;

FIGS. 2 and 3 are graphs illustrating a variation in the power of light reflected, depending on the distance, respectively;

FIG. 4 is a view illustrating another principle of the measuring method using an optical fiber lens in accordance with the present invention;

FIG. 5 is a block diagram illustrating a measuring apparatus according to a first embodiment of the present invention; and

FIG. 6 is a block diagram illustrating a measuring apparatus according to a second embodiment of the present invention.

### DESCRIPTION OF THE PREFERRED EMBODIMENTS

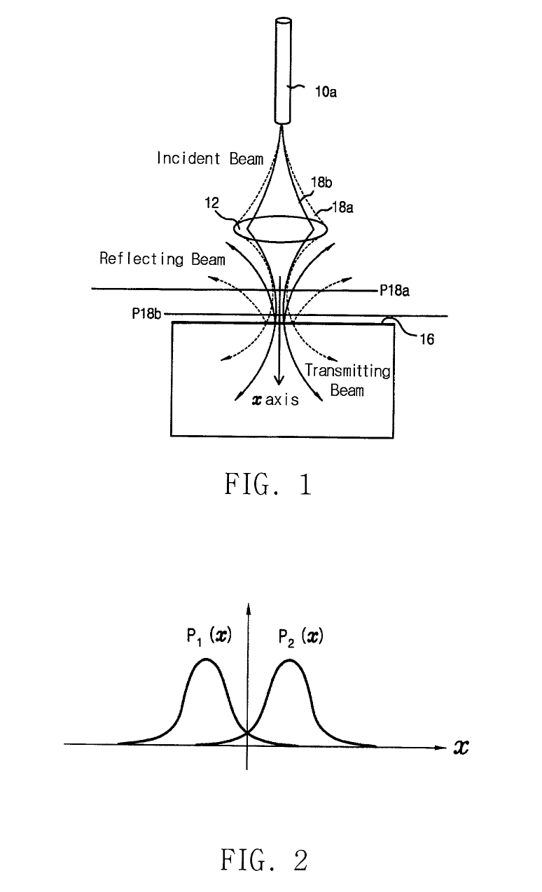

Now, preferred embodiments of the present invention will be described in detail, with reference to FIGS. 1 to 6.

The present invention provides a technical idea for measuring the refractive index distribution of an optical fiber or waveguide by measuring variation in reflectivity on the surface of the optical fiber or waveguide depending upon the position on the surface of the optical fiber or waveguide while scanning the optical fiber or waveguide surface at a fixed scanning height using three laser beams of different wavelengths projected onto the optical fiber or waveguide surface.

FIG. 1 schematically illustrates two laser beams 18a and 18b, respectively having different wavelengths λ1 and λ2 (λ1<λ2), guided along a single optical fiber 10a and focused by a lens 12.

Referring to FIG. 1, it can be found that two laser beams 18a and 18b, respectively having different wavelengths λ1 and λ2 (λ1<λ2), guided along a single optical fiber 10a and focused by a lens 12 form focuses at different positions by virtue of a refractive index difference between the materials of the optical fiber 10a and lens 12 depending on the wavelength λ.

In other words, one of the two laser beams 18a and 18b, that is, the laser beam 18a having a short wavelength λ1, exhibits a divergence angle more than that of the laser beam 18b having a long wavelength λ2 while having a focusing distance less than that of the laser beam 18b. As a result, the laser beam 18b having the short wavelength λ1 forms a beam waist (corresponding to a state in which the laser beam has a minimum diameter) at a position pl8a closer to the lens 12 than the beam waist position p18b of the laser beam 18b having the long wavelength λ2.

As an optical fiber surface 16, onto which the laser beams 18a and 18b are incident, is closer to the beam waist positions p18a and p18b of the laser beams 18a and 18b, the amounts and divergence angles of the laser beams 18a and 18b reflected by the optical fiber surface 16 are similar to the incidence amounts and angles of the laser beams 18a and 18b, respectively. As a result, the light power guided again to the optical fiber 10a in backward direction after being reflected by the surface 16 is increased.

FIG. 2 illustrates respective powers of the laser beams 18a and 18b, P₁(x) and P₂(x), guided again to the optical fiber 10 in backward direction after being reflected by the optical fiber surface 16, depending on the distance, x, between the optical fiber 10 and the lens 12.

Where each of the leaser beams 18a and 18b are focused onto the optical fiber surface 16, the light power guided again to the optical fiber 10a after the reflection is maximized.

Accordingly, the peak of the power P₁(x) of the short-wavelength laser beam 18a coupled to the optical fiber 10a after being reflected exists at a position left from the position at which the peak of the power P₂(x) of the long-wavelength laser beam 18b coupled to the optical fiber 10a after being reflected, as shown in FIG. 2.

Assuming that the distance x corresponds to 0 at the intermediate point between the beam waist positions in x axis of the two laser beams, the value obtained after subtracting the light power P₂(x) from the light power P₁(x) is positive when the distance x is smaller than 0 while being negative when the distance x is larger than 0.

In particular, where the distance x approximates to 0, the value “P₁(x)−P₂(x)” is linearly proportional to the distance x.

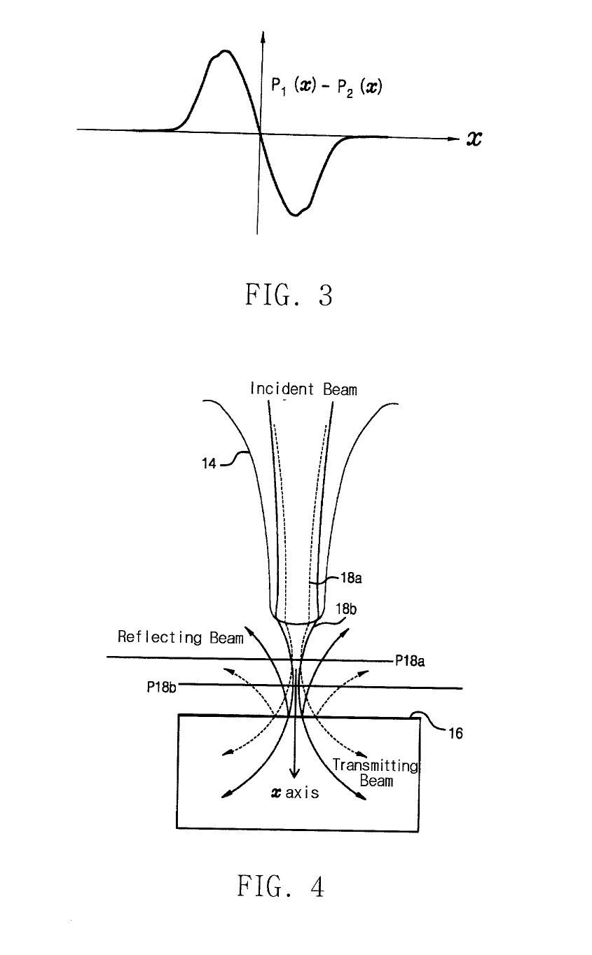

That is, the value obtained after subtracting the light power corresponding to the first wavelength, λ1, from the light power corresponding to the second wavelength λ2, that is, the value “P₁(x)−P₂(x)” varies linearly depending on the distance x, as shown in the central portion of FIG. 3.

The value “P₁(x)−P₂(x)” is 0 when the distance x corresponds to 0, and varies in proportional to variation in the distance x from 0. Accordingly, it is possible to position the optical fiber surface 16 at a position spaced apart from the focus of a laser beam by a constant distance, based on the value “P₁(x)−P₂(x)”, by amplifying value “P₁(x)−P₂(x)”, and then feeding back the amplified value to a device for adjusting the focusing position of the laser beam.

Meanwhile, reflectivity R has a relation with refractive index n, as expressed by the following Expression 1.

$$R = {( \frac{n - 1}{n + 1} )}^{2} \qquad \text{[Expression 1]}$$

Accordingly, if the distribution of the relative reflectivity R of a laser beam incident onto an optical fiber is known, it is then possible to calculate the distribution of the relative refractive index n of the optical fiber 16. Where the optical fiber has a portion, for which the absolute refractive index is known, such as a cladding, it is possible to determine the distribution of the absolute refractive index other than the distribution of the relative refractive index.

FIG. 4 schematically illustrates two laser beams 18a and 18b, respectively having different wavelengths λ1 and λ2 (λ1<λ2), focused after being guided along a single optical fiber lens 14.

Where the optical fiber lens 14 is used in place of the optical fiber 10a and lens 12, there is an advantage in that the apparatus can be further simplified. Also, the apparatus is not influenced by the environmental condition such as impact.

In this case, the beam waist positions p18a and p18b of two laser beams 18a and 18b respectively having different wavelengths λ1 and λ2 (λ1<λ2) are different from each other. Accordingly, respective amounts of the laser beams 18a and 18b coupled to the optical fiber lens 14 after being reflected exhibit characteristics shown in FIGS. 2 and 3, similar to the case using the lens 12 having a general configuration.

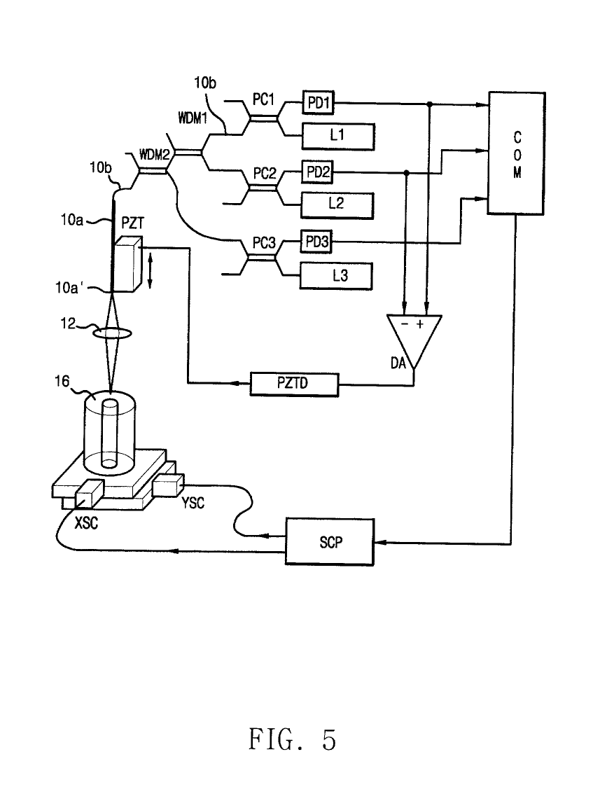

FIG. 5 illustrates a apparatus measuring a refractive index profile using wavelength division multiplexing couplers and a confocal method in accordance with a first embodiment of the present invention based on the above mentioned principle. In FIG. 5, elements respectively corresponding to those in FIG. 1 are denoted by the same reference numerals.

As shown in FIG. 5, the apparatus measuring a refractive index profile includes a lens 12 for focusing three laser beams respectively emitted from lasers L1, L2 and L3 of different wavelengths and outputted from one end 10a′ of an optical fiber 10a while guiding those laser beams reflected by a reflection surface 16 to be measured in terms of a refractive index profile, a piezoelectric transducer PZT for adjusting the distance between the optical fiber end 10a′ and the lens 12 in proportional to a voltage generated by virtue of an power difference between the laser beam emitted from the laser L1 having a short wavelength and the laser beam emitted from the laser L2 having a long wavelength, and wavelength division multiplexing couplers WDM1 and WDM2 for guiding the laser beams emitted from the lasers L1, L2, and L3 along an optical fiber 10b or allowing the laser beams, reflected after passing through the optical fiber lob, to be fed back to the lasers L1, L2, L3, respectively. The apparatus also includes optical fiber couplers PC1, PC2, and PC3 for dividing or coupling the light beams emerging from the lasers L1, L2, and L3, respectively, optical fiber detectors PD1, PD2, and PD3 for measuring respective powers of laser beams emerging from the optical fiber couplers PC1, PC2, and PC3, a differential amplifier DA for amplifying the power difference between the laser beams respectively emerging from the optical fiber detectors PD1 and PD2, and x and y-axis scanners XSC and YSC for scanning the reflection surface 16 to allow the optical fiber detector PD3 to detect the power of the laser beam emitted from the laser L3 having an intermediate wavelength and reflected by the reflection surface 16, thereby allowing a measurement of the refractive index profile of the reflection surface 16 based on the detection result of the optical fiber coupler PC3.

In place of the wavelength division multiplexing couplers WDM1 and WDM2, optical fiber couplers may be used to guide three or more wavelengths to the single optical fiber 10b.

Where three lasers L1, L2, and L3 of different wavelengths are used, and a feedback loop is established to maintain the power of the long-wavelength laser beam emitted from the laser L1 and the power of the short-wavelength laser beam emitted from the laser L3, the power of the intermediate-wavelength laser beam emitted from the laser L2 is minimized at the reflection surface 16.

In accordance with the present invention, it is possible to measure the refractive index profile of the reflection surface 16 by detecting a variation in reflectivity on the reflection surface 16 with respect to the intermediate-wavelength laser beam emitted from the laser L2 while scanning the reflection surface 16.

This will now be described in detail.

Laser beams respectively emitted from the lasers L1 and L2 of different wavelengths are guided to the single optical fiber 10b by the wavelength division multiplexing couplers WDM1.

Subsequently, the laser beams emerge from the end 10a′ of the optical fiber 10a after passing through the optical fiber 10a, while having different power and divergence angles, respectively. Since the laser beams have different power and divergence angles, respectively, they are focused by the lens 12 at different positions, as shown in FIG. 1.

Assuming that λ₁ and λ₂ represent the wavelength of the laser beam emitted from the short-wavelength laser L1, respectively, the beam waist of the laser beam having the wavelength λ₁ is closer to the lens 12 than the beam waist of the laser beam having the wavelength λ₂. The λ₁ and λ₂-laser beams are then reflected by the reflection surface 16, so that they are guided again to the optical fiber 10a via the lens 12.

The λ₁-laser beam is then guided toward the laser L1 by the wavelength division multiplexing couplers WDM 1. Also, the λ₂-laser beam is guided toward the laser L2 by the wavelength division multiplexer WDM 1. The λ₁ and λ₂-laser beams are subsequently detected by the photo-detectors PD1 and PD2 after passing through the optical fiber couplers PC1 and PC2, respectively. Each of the optical fiber couplers PC1 and PC2 may be a 50:50 optical fiber coupler. Based on the result of the detection, each of the photo-detectors PD1 and PD2 generates a electronic signal as current or voltage.

The amounts of light respectively detected by the photo-detectors PD1 and PD2 exhibit characteristics shown in FIG. 2. The output electronic signals from the photo-detectors PD1 and PD2 applied to the differential amplifier DA which is constituted by an OP amplifier. The differential amplifier DA subtracts the output signal of the photo-detector PD2 from the output signal of the optical fiber detector PD1, thereby generating a signal as shown in FIG. 3. This signal is amplified and then applied to a piezoelectric transducer driving unit PTZD which, in turn, generates a control signal based on the signal applied thereto.

The control signal is applied to the piezoelectric transducer PZT which, in turn, shifts the optical fiber end 10a′ with respect to the lens 12 in proportion to the voltage applied thereto.

The piezoelectric transducer PZT adjusts the distance x between the optical fiber end 10a and lens 12 in such a fashion that the difference between the outputs of the photo-detectors PD1 and PD2 corresponds to 0, thereby causing the reflection surface 16 to be always positioned at an intermediate point between the beam waists of the laser beams respectively emitted from the lasers L1 and L2.

Where the laser beam emitted from the laser L3 having a wavelength intermediate between the wavelengths of the lasers L1 and L2 is guided to the optical fiber 10b using another wavelength division multiplexer WDM2, the beam waist of the laser beam emitted from the laser L3 is always positioned on the reflection surface 16. At this time, a maximum horizontal resolution is obtained.

When the x and y-axis scanners XSC and YSC are driven by an x-y scanner driving unit SCP to allow the reflection surface 16 to be scanned by the laser beam emitted from the intermediate-wavelength laser L3, the optical fiber detector PD3 detects the power of the intermediate-wavelength laser beam reflected by the reflection surface 16. Based on the detection result of the optical fiber detector PD3, accordingly, the refractive index profile of the reflection surface 16 can be determined using Expression 1.

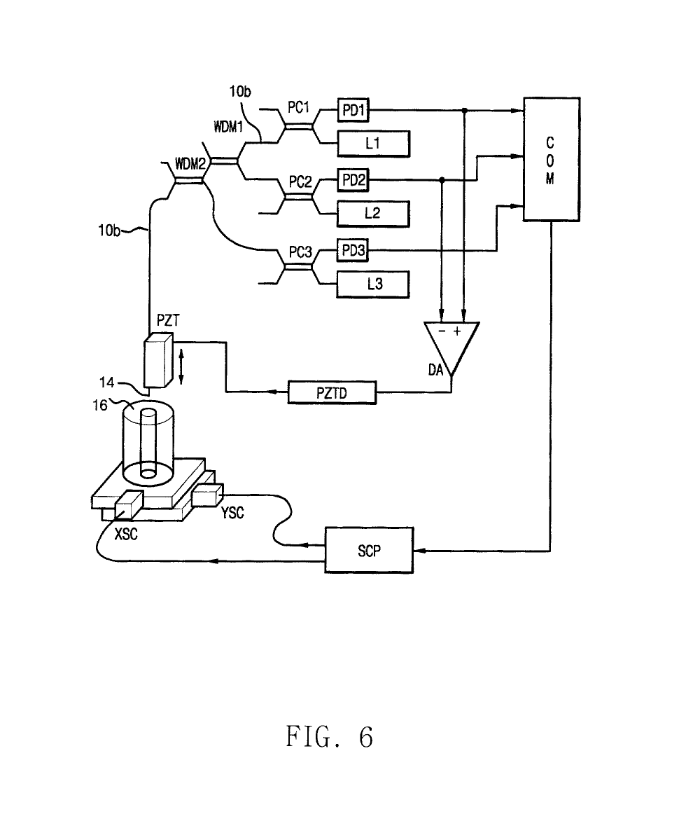

FIG. 6 illustrates a refractive index profile measuring apparatus using three lasers of different wavelengths and wavelength division multiplexing couplers in accordance with a second embodiment of the present invention. This apparatus operates in the same fashion as the apparatus of FIG. 5, except that an optical fiber lens 14 is used in place of the cleaved optical fiber 10a and lens 12.

In the case of FIG. 6, laser beams respectively emitted from the lasers L1 and L2 having different wavelengths are guided to the single optical fiber 10b by the wavelength division multiplexer WDM1.

Subsequently, the laser beams emerge from the optical fiber lens 14 after passing through the optical fiber 10a, while having different power and divergence angles, respectively. Since the laser beams have different power and divergence angles, respectively, they are focused at different positions, as shown in FIG. 4.

Assuming that λ₁ and λ₂ represent the wavelength of the laser beam emitted from the short-wavelength laser L1, respectively, the beam waist of the laser beam having the wavelength λ₁ is closer to the optical fiber lens 14 than the beam waist of the laser beam having the wavelength λ₂. The λ₁ and λ₂-laser beams are then reflected by the reflection surface 16, so that they are guided again to the optical fiber 10b via the optical fiber lens 14.

The λ₁-laser beam is then guided toward the laser L1 by the wavelength division multiplexer WDM 1. Also, the λ₂-laser beam is guided toward the laser L2 by the wavelength division multiplexer WDM 1. The λ₁ and λ₂-laser beams are subsequently detected by the optical fiber detectors PD1 and PD2 after passing through the 50:50 optical fiber couplers PC1 and PC2, respectively. Based on the result of the detection, each of the optical fiber detectors PD1 and PD2 generates a voltage signal.

The amounts of light respectively detected by the optical fiber detectors PD1 and PD2 exhibit characteristics shown in FIG. 2. The output signals from the optical fiber detectors PD1 and PD2 applied to the differential amplifier DA which is constituted by an OP amplifier. The differential amplifier DA subtracts the output signal of the optical fiber detector PD2 from the output signal of the optical fiber detector PD1, thereby generating a signal as shown in FIG. 3. This signal is amplified and then applied to the piezoelectric transducer driving unit PTZD which, in turn, generates a control signal based on the signal applied thereto.

The control signal is applied to the piezoelectric transducer PZT which, in turn, shifts the optical fiber lens 14 with respect to the reflection surface 16 in proportion to the voltage applied thereto.

The piezoelectric transducer PZT adjusts the distance between the optical fiber lens 14 and the reflection surface 16 in such a fashion that the difference between the outputs of the optical fiber detectors PD1 and PD2 corresponds to 0, thereby causing the reflection surface 16 to be always positioned at an intermediate point between the beam waists of the laser beams respectively emitted from the lasers L1 and L2.

Where the laser beam emitted from the laser L3 having a wavelength intermediate between the wavelengths of the lasers L1 and L2 is guided to the optical fiber 10b using another wavelength division multiplexer WDM2, the beam waist of the laser beam emitted from the laser L3 is always positioned on the reflection surface 16. At this time, a maximum horizontal resolution is obtained.

When the x and y-axis scanners XSC and YSC are driven by an x-y scanner driving unit SCD to allow the reflection surface 16 to be scanned by the laser beam emitted from the intermediate-wavelength laser L3, the optical fiber detector PD3 detects the power of the intermediate-wavelength laser beam reflected by the reflection surface 16. Based on the detection result of the optical fiber detector PD3, accordingly, the refractive index profile of the reflection surface 16 can be determined using Expression 1.

As apparent from the above description, in accordance with the refractive index profile measuring method according to the present invention, laser beams respectively emitted from three lasers L1, L2, and L3 having different wavelengths are guided along the single optical fiber 10b, and then guided in such a fashion that they are incident onto the reflection surface 16 after emerging from the optical fiber 10a while being partially reflected by the reflection surface 16 and then guided again in backward direction to the optical fiber 10a. The intensities of the laser beams respectively emitted from the short-wavelength laser L1 and long-wavelength laser L2 and fed back after being reflected under the above mentioned condition are detected. The difference between the detected intensities is fed back via the feedback loop. Based on the power difference, a servo control is made to allow the reflection surface 16 to be always positioned at the focus of the laser beam emitted from the laser L3 having an intermediate wavelength. Under this condition, the power of the intermediate-wavelength laser beam fed back after being reflected by the reflection surface 16 is detected as the reflection surface 16 is scanned. Based on the result of the detection, the reflective index profile is derived using the expression

$$“ R = {( \frac{n - 1}{n + 1} )}^{2} ” .$$

As apparent from the above description, in accordance with the present invention, it is possible to obtain a high spatial resolution, as compared to the conventional measuring apparatus using a refraction phenomenon. In accordance with the present invention, it is possible to remarkably reduce measuring errors because a high signal-to-noise ratio is provided, as compared to the conventional measuring apparatus using a scanning near field optical microscope. Also, there is an effect capable of achieving a precise measurement for the refractive index distribution essentially required in the design and manufacture of optical fibers or waveguides with a micro structure.

In accordance with the present invention, it is unnecessary to use any expensive device. In particular, the measuring method is very simple, as compared to conventional refractive index measuring devices commercially available. In this regard, the present invention can be easily implemented for commercial use.

In accordance with the present invention, it is also possible to achieve a desired refractive index measurement while simply achieving the maintenance of the focusing distance without using any complex circuit or device, as compared to conventional methods in which the focus of a laser beam is maintained using a dithering method.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for measuring the refractive index profile of an optical fiber or waveguide surface comprising:
a lens for focusing three laser beams respectively emitted from first through third lasers of different wavelengths and outputted from one end of an output optical fiber after passing though an input optical fiber, while guiding, to the output optical fiber, the laser beams reflected by a reflection surface to be measured in terms of a refractive index profile,
a piezoelectric transducer for adjusting a distance defined between the end of the output optical fiber and the lens in proportional to a voltage generated by virtue of an power difference between the laser beam emitted from the first laser having a short wavelength and the second laser having a long wavelength;
wavelength division multiplexing couplers for guiding the laser beams emitted from the first through third lasers along the input optical fiber while allowing the laser beams, reflected after passing through the output optical fiber, to be fed back to the first through third lasers, respectively;
first through third optical fiber couplers for dividing or coupling the light beams emerging from the first through third lasers, respectively;
first through third optical fiber detectors for measuring respective intensities of laser beams outputted from the first through third optical fiber couplers;
a differential amplifier for subtracting the power of the laser beam outputted from the second optical fiber detector from the power of the laser beam outputted from the first optical fiber detector, and amplifying the power difference obtained by the subtraction; and
x and y-axis scanners for scanning the reflection surface to allow the third optical fiber detector to detect the power of the laser beam emitted from the third laser having an intermediate wavelength and reflected by the reflection surface;
whereby the refractive index profile of the reflection surface is measured based on the detection result of the third optical fiber coupler.

2. The apparatus according to claim 1, wherein an optical fiber lens is coupled to the input optical fiber, in place of the output optical fiber and the lens, and the piezoelectric transducer is adapted to adjust a distance defined between the optical fiber lens and the reflection surface.

3. The apparatus according to claim 1, wherein each of the first through third optical fiber couplers is a 50:50 coupler.

4. A method for measuring the refractive index profile of an optical fiber or waveguide surface, comprising the steps of:
scanning a surface of an optical fiber or waveguide at a fixed scanning height using three laser beams of different wavelengths projected onto the optical fiber or waveguide surface; and
measuring a variation in reflectivity on the optical fiber or waveguide surface depending upon a variation in scanning position on the optical fiber or waveguide surface, thereby measuring the refractive index distribution of the optical fiber or waveguide.

5. A method for measuring the refractive index profile of an optical fiber or waveguide surface, comprising the steps of:
guiding laser beams respectively emitted from three lasers of different wavelengths along an input optical fiber, guiding the laser beams to be incident onto a reflection surface after emerging from an output optical fiber while being partially reflected by the reflection surface and then guided again to the output optical fiber;
detecting the intensities of the laser beams respectively emitted from a short-wavelength one of the lasers and a long-wavelength one of the lasers and fed back after being reflected by the reflection surface, feeding back an power difference between the detected intensities via a feedback loop, and conducting, based on the fed-back power difference, to allow the reflection surface to be always positioned at a focus of the laser beam emitted from an intermediate-wavelength one of the lasers; and
detecting the power of the intermediate-wavelength laser beam fed back after being reflected by the reflection surface while scanning the reflection surface, and deriving a refractive index, based on the result of the detection.

6. The method according to claim 5, wherein the laser beams respectively emitted from the three lasers are guided to the input optical fiber by wavelength division multiplexing couplers.

7. The method according to claim 5, wherein the laser beams respectively emitted from the three lasers are guided to the input optical fiber by optical fiber couplers.
